(19) United States
(12) Patent Application Publication
(10) Pub. No.: US 2018/0132007 A1
(43) Pub. Date: May 10, 2018

(54) CROWDSOURCED TEXT CAPTIONING CORRECTIONS AND AUGMENTATION

(71) Applicant: International Business Machines Corporation, Armonk, NY (US)

(72) Inventors: Philip J. Chou, Poughkeepsie, NY (US); Rajaram B. Krishnamurthy, Pleasant Valley, NY (US); Christine D. Mikijanic, Monroe, NY (US); Conner W. Simmons, Hopewell Junction, NY (US)

(21) Appl. No.: 15/347,284

(22) Filed: Nov. 9, 2016

(51) Int. Cl. H04N 21/472; H04N 21/488; H04N 21/235; H04N 21/25; H04N 21/475

(52) U.S. Cl. CPC H04N 21/47205; H04N 21/4884; H04N 21/4758; H04N 21/252; H04N 21/2353

(57) ABSTRACT

An approach to creating crowdsourced submissions to improve text captioning associated with a video stream is provided, the approach involves providing, by a captioning submission program, one or more user interface (UI) components for enabling a user to generate an indication of a text captioning error associated with the video stream, receiving, by the captioning submission program, the indication of the text captioning error from the user and sending, by the captioning submission program, a submission to a database for further processing to improve the text captioning associated with the video stream, wherein the submission provides crowdsourced feedback of the text captioning and comprises the indication of the text captioning error.

### BACKGROUND

The present invention relates generally to the field of text captioning, and more particularly to text captioning based on crowdsourcing.

Text captioning is the addition of subtitles or text to a video stream, e.g., a live or prerecorded video stream on television (TV) or the Internet. Text captioning, including closed captioning, subtitles, and the like, can be used to present dialogue and contextual information associated with the events of a video stream in real time. As an accessibility feature, text captioning is useful for those with disabilities or impairments (such as deafness) or otherwise a useful feature for viewers in a noisy environment.

Crowdsourcing refers generally to situations where a plurality of individual people contribute submissions (e.g., ideas, services and/or information) to a project or joint effort. In the modern computing age, crowd sourced content is in many cases submitted via the Internet. Crowdsourcing can enable a collective brainstorming where a wide range and diversity of ideas and perspectives are collected and used towards a common purpose. Crowdsourced content and submissions may be further filtered and processed by a variety of means, e.g., human analysis, algorithmic analysis, cognitive analysis, etc.

### SUMMARY

According to one embodiment of the present invention, a method for creating crowdsourced submissions to improve text captioning associated with a video stream is provided. The method provides, by a captioning submission program, one or more user interface (UI) components for enabling a user to generate an indication of a text captioning error associated with the video stream. The method receives, by the captioning submission program, the indication of the text captioning error from the user. The method sends, by the captioning submission program, a submission to a database for further processing to improve the text captioning associated with the video stream, wherein the submission provides crowdsourced feedback of the text captioning and comprises the indication of the text captioning error. A corresponding computer program product and computer system are also disclosed herein.

### BRIEF DESCRIPTION OF THE DRAWINGS

FIG. 1 is a functional block diagram illustrating a distributed data processing environment, in accordance with an embodiment of the present invention;

FIG. 2 is a flowchart illustrating operations of a captioning submission program, in accordance with an embodiment of the present invention;

FIGS. 3A-B are an example of text captioning with errors and a user interface for creating text captioning submissions, respectively, in accordance with an embodiment of the present invention; and

FIG. 4 is a block diagram of components of a computer system executing the captioning submission program, in accordance with an embodiment of the present invention.

### DETAILED DESCRIPTION

Text captioning is a feature offered by many video streaming platforms for enabling viewers to read textual information associated with the events of a video stream. However, the text captioning of a video stream may not always be complete, accurate or correct. Some viewers may have an awareness of how the captioning associated with a video stream may be improved or corrected for errors but not have a means by which to submit suggestions or changes. With this in mind, embodiments of the present invention provide a solution wherein viewers of a video stream, utilizing an associated text captioning system, can submit suggestions and/or proposed changes to the text captioning for the benefit of others who will also view the same video stream. Users can submit suggestions or proposed changes via a capable device connected to a network (e.g., the Internet), wherein the crowdsourced submissions can be aggregated and further processed for improving the text captioning of video streams.

In describing embodiments in detail with reference to the figures, it should be noted that references in the specification to “an embodiment,” “other embodiments,” etc., indicate that the embodiment described may include a particular feature, structure, or characteristic, but every embodiment may not necessarily include the particular feature, structure, or characteristic. Moreover, such phrases are not necessarily referring to the same embodiment. Further, describing a particular feature, structure or characteristic in connection with an embodiment, one skilled in the art has the knowledge to affect such feature, structure or characteristic in connection with other embodiments whether or not explicitly described.

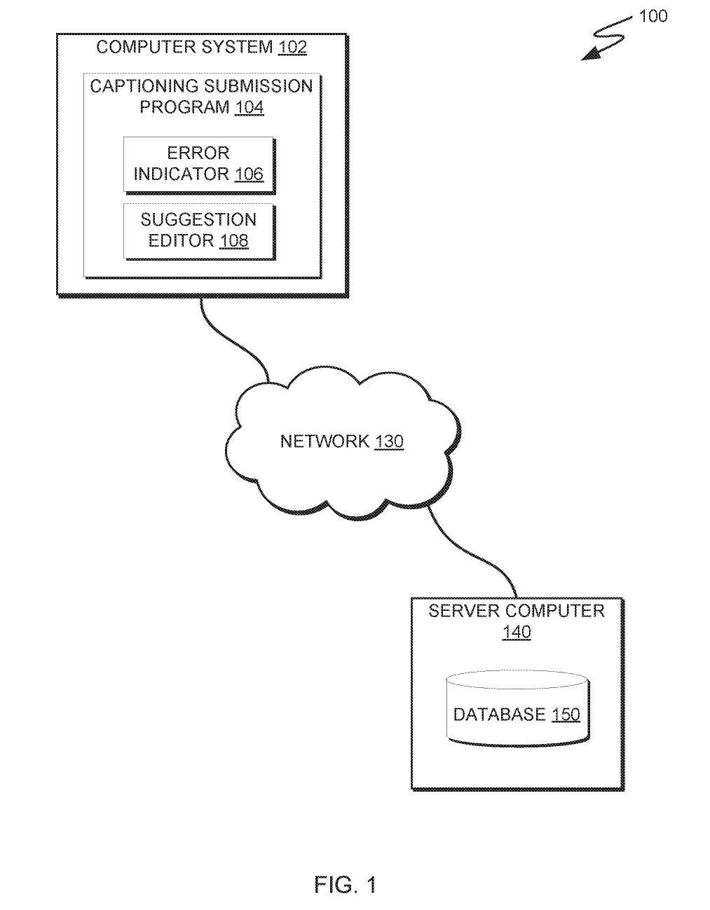

The present invention will now be described in detail with reference to the figures. FIG. 1 is a functional block diagram illustrating a distributed data processing environment 100, in accordance with one embodiment of the present invention. Distributed data processing environment 100 comprises computer system 102 and server computer 140, all interconnected over network 130.

Computer system 102 can be a laptop computer, tablet computer, netbook computer, personal computer (PC), a desktop computer, a personal digital assistant (PDA), a smart phone, a smart TV, or any programmable electronic device capable of communicating with server computer 140 via network 130. Computer system 102 comprises captioning submission program 104 for indicating errors and/or proposing changes and augmentations to text captioning. A user of computer system 102 watching a video stream with text captioning can use captioning submission program 104 to submit an indication that there is an error with the text captioning, propose a correction to the text captioning if desired, or otherwise propose a change, comment or suggestion for improving the text captioning.

Captioning submission program 104 comprises error indicator 106 and suggestion editor 108. Error indicator 106 is a component enabling a user to indicate that they have seen an error in text captioning associated with a video stream they are viewing. Error indicator 106 can enable a user to indicate a timestamp range during which they believe an error has occurred in the text captioning. Error indicator 106 further enables viewers of a video stream to create and submit edits, e.g., proposed corrections, to text captioning. For example, viewers may type out a proposed correction to the text captioning associated with a video stream and indicate a timestamp range to which the proposed correction corresponds.

Suggestion editor 108 is a component enabling viewers of a video stream to create submissions such as, but not limited to, comments, suggestions and/or additional information associated with the video stream. Viewers can, for example, enter comments (via suggestion editor 108) associated with the text captioning (though not necessarily pertaining to a text captioning error) for a specific timestamp range of the video stream or for the text captioning of the video stream as whole. It should be noted that timestamp range as the term is used herein can refer to a particular segment of time associated with a video stream, e.g., a timestamp range of 1:55-2:00 in a three minute long (3:00) video.

In some embodiments, a viewer is watching, on computer system 102, a live or prerecorded video stream on a platform providing the option for text captioning. Some examples of video streaming platforms include, but are not limited to, online video streaming services (e.g., accessible via a web browser) and television programming on a smart TV. In other embodiments, a viewer can be watching a live or prerecorded video stream on a device separate from computer system 102, such as another computing device or television.

Server computer 140 can be any computer system capable of receiving submissions from captioning submission program 104 and/or broadcasting content (e.g., live or prerecorded video streams) via network 130. Server computer 140 comprises database 150 for storing user submissions associated with the video stream text captioning, submitted via captioning submission program 104. Submissions stored in database 150 can be further processed by server computer 140, as will subsequently be discussed in greater detail.

Network 130 can be, for example, a local area network (LAN), a wide area network (WAN) such as the Internet, or a combination of the two, and can include wired, wireless, or fiber optic connections. In general, network 130 can be any combination of connections and protocols that will support communications between computer system 102 and server computer 140.

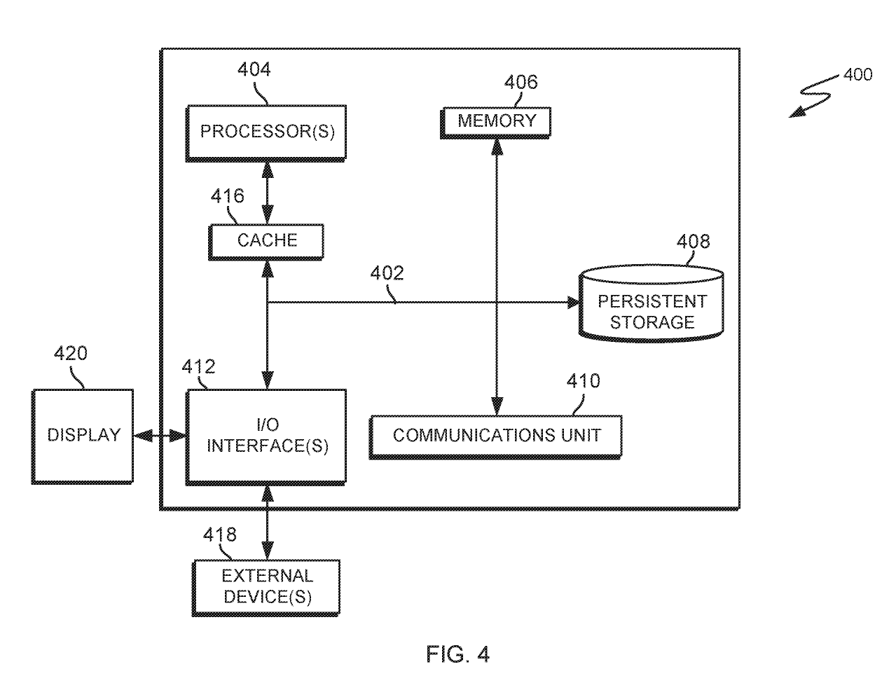

Computer system 102 may include internal and external hardware components, as depicted and described in further detail with respect to FIG. 4.

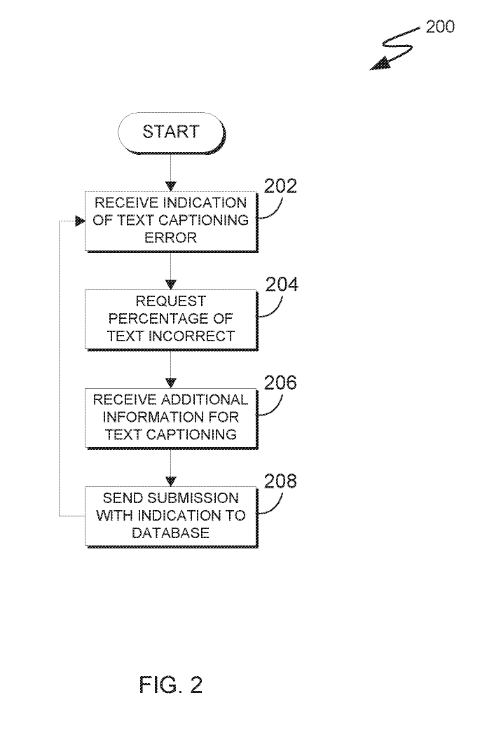

FIG. 2 is a flowchart 200 depicting operations of captioning submission program 104 for enabling users to submit suggestions, augmentations or corrections to text captioning associated with video streams, in accordance with an embodiment of the present invention. The illustrative example of FIG. 2 is provided to facilitate discussion of aspects of the present invention, and it should be appreciated that FIG. 2 provides only an illustration of an embodiment of the present invention and does not imply any limitations with regard to the variations or configurations in which different embodiments may be implemented.

Error indicator 106 receives an indication from a user that an error is present in text captioning associated with a video stream they are viewing (operation 202). The user can provide indication that they have detected an error in a plurality of ways. Sometimes, for example, the user may want to simply indicate that there is an error in the text captioning during a specific time in the video stream, even if they do not know what exactly the error is or how to correct it. Error indicator 106 provides one or more user interface (UI) components, such as, but not limited to, a button which the user can select at the time of the error occurrence (or at any time during the video stream) to provide general indication that they have seen an error in text captioning. The user can optionally enter, in a provided text field, a timestamp range during which they believe the error occurred. Alternatively, a timestamp and/or timestamp range is automatically collected by error indicator 106 when the user selects the button to provide indication of the error.

In a provided text field, the user can optionally provide further information associated with a text captioning error they have noticed and/or provide a proposed correction to the error. For example, the user notices a text captioning error in the video stream, clicks the button to generally indicate that an error has occurred, then enters information (e.g., a comment) associated with the error such as “Incorrect spelling.” Alternatively, the user can enter a proposed correction to the text captioning error in the text field, with the proposed correction intended to replace the error. In some embodiments, error indicator 106 requests the user to enter a percentage (e.g., a whole number percentage from 1%-100%) associated with how incorrect they believe the text captioning error is (operation 204). In other embodiments, users may willingly elect to enter such a percentage, e.g., in the text field, even if it is not requested.

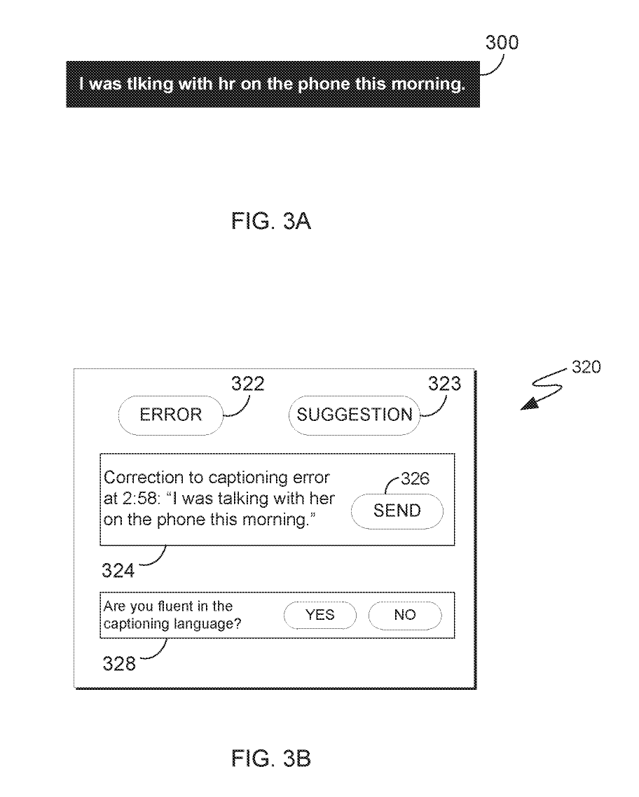

As another example, the user can enter (in a provided text field) an exact portion of text from the text captioning of the video stream that they believe has an error. Users can provide specific details as to the intended meaning or use of any text they enter, as will be depicted and described in greater detail with respect to FIG. 3B. The user can additionally indicate whether or not they are fluent the language being presented in the text captioning. Any of the aforementioned examples of how an error may be indicated can be used in any combination to provide feedback for improving text captioning associated with the video stream.

Captioning submission program 104 receives, from suggestion editor 108, entries such as, but not limited a suggestion, a comment or a proposed augmentation to text captioning, entered by a user (operation 206). Information entered via suggestion editor 108 may not be associated with an error in text captioning, but rather with general or specific suggestions, comments, recommendations, augmentations or the like for otherwise improving the text captioning associated with a video stream. For example, a user may choose to provide information via suggestion editor 108 that is intended to provide context for a particular scene of the video stream they are viewing. The user may recommend that additional text captioning be provided (i.e., an augmentation) during a particular scene which indicates to viewers the relationship of an infrequently appearing character to the main characters who appear more frequently.

Additionally or alternatively, the user may provide information via suggestion editor 108 that would be helpful to viewers with various physical impairments. For example, the user may enter a description of how a room is suddenly being lit up with sunshine during a certain scene of a video stream for the benefit of viewers with colorblindness. Many such examples may be apparent to one of ordinary skill in the art implementing embodiments of the present invention. Any information entered via suggestion editor 108 can include a timestamp range for indicating a portion or scene of the video stream to which the entered information pertains.

Captioning submission program 104 sends an entered submission, associated with text captioning in a video stream, to server computer 140, comprising database 150 (operation 208). The entered submission comprises any of a text captioning error indication (e.g., with additional information about the error, a timestamp, a proposed correction, etc.), a comment, a suggestion, a recommendation, and/or an augmentation to the text captioning, such as previously described. Submissions are sent to database 150 where they can be collected and aggregated for further processing to improve the text captioning associated with the video stream.

Database 150 receives crowdsourced submissions from one or more viewers of a video stream (i.e., using captioning submission program 104 on one or more separate computing devices), the submissions being associated with text captioning in the video stream. The received submissions can be processed by server computer 140 in a variety of ways, such as, but not limited to, an algorithmic approach, processing by a cognitive analysis engine, human analysis of the submissions or any combination thereof. In this manner, the crowdsourced submissions from different viewers are analyzed and used to refine, improve and augment the text captioning associated with the video stream on an ongoing basis.

FIG. 3A depicts text captioning 300 associated with a video stream that a user of computer system 102 is viewing, in accordance with an embodiment of the present invention. The user has enabled text captioning which displays dialogue of the video stream as text. The video stream may be from a video streaming website the user is viewing on computer system 102, for example. Text captioning 300 has two spelling errors; “tlking” and “hr”, which the user notices while viewing the video stream.

FIG. 3B depicts panel 320 for indicating an error in text captioning, in accordance with an embodiment of the present invention. Panel 320 comprises ERROR button 322, SUGGESTION button 323, text field 324 and fluency indicator 328. Panel 320, associated with captioning submission program 104, can be embodied as a module in a video streaming service, e.g., a video streaming website or application. In other embodiments, captioning submission program 104 can be a separate application on computer system 102 for entering submissions associated with a video stream a user is watching on another application or device. In such an embodiment, the user may provide information to associate their submission with a particular video stream, e.g., the user provides a URL associated with the video stream and/or an associated video streaming platform and title, etc.

The user of computer system 102, noticing the errors associated with text captioning 300, selects ERROR button 322. In some embodiments, the user is prompted with a message (not shown), responsive to a selection of ERROR button 322, requesting them to indicate (e.g., in text field 324) any of a timestamp range for the error(s), a percentage of incorrectness, a correction to the error(s) and/or any additional information about the error(s).

The user noticing the errors (associated with text captioning 300) provides the following information in text field 324: “Correction to captioning error at 2:58: ‘I was talking with her on the phone this morning.’” When the user has finished entering their message, they can select SEND button 326 (associated with text field 324) to initiate transfer of the message pertaining to the text captioning error.

Additionally or alternatively, the user can select SUGGESTION button 323. In some embodiments, responsive to a selection of SUGGESTION button 323, the user is prompted to enter (e.g., in text field 324) any of a suggestion, a comment, a recommendation an augmentation or the like pertaining to the text captioning, along with an associated timestamp range. For example, in the user viewing the video stream may hear crickets chirping in the video stream during a certain segment while there is no text dialogue, yet the user does not see any captioning indicating that crickets can be heard chirping. The user therefore selects SUGGESTION button 323 and enters in text field 324 “*crickets chirping* 4:27-4:35.” This is an indication that additional text captioning can be added to the video stream (i.e., an augmentation) at the indicated timestamp range to notify viewers that crickets can be heard chirping.

It should be noted that in some embodiments, responsive to a user selection of ERROR button 322 and/or SUGGESTION button 323, captioning submission program 104 automatically collects a timestamp of the video stream, associated with the time of the selection.

In addition, to providing an error and/or a suggestion associated with the text captioning, the user may further use fluency indicator 328 to indicate whether or not they are fluent in the language associated with the text captioning. In FIG. 3B, fluency indicator 328 is a sub-panel comprising the message “Are you fluent in the captioning language?” and a YES and a NO button. The user can select either YES or NO to provide further helpful information about their relevant experience with the language associated with the text captioning.

In the previously described examples associated with FIG. 3B, ERROR button 322 and SUGGESTION button 323 are intended to be used to provide a general indication of the type of submission that a user will enter into text field 324 to be submitted to a database (e.g., database 150). Submissions received by database 150 can be aggregated and further processed for improving text captioning associated with the video stream, as previously discussed.

It should also be noted that the text captioning errors can be more complex than spelling errors, such as those presented in FIG. 3A. For example, text captioning associated with a video stream may be grammatically correct and without spelling errors, but logically incomprehensible and/or contextually irrelevant to viewers. In some cases, text captioning errors can comprise any combination of spelling errors, grammar errors, logically incomprehensible statements and/or text that does not match the corresponding audio dialogue associated with the video stream. Embodiments of the present invention therefore enable viewers to indicate errors and create text captioning submissions for any type of text captioning error they believe they have noticed.

The illustrative examples of FIGS. 3A and 3B are provided to facilitate discussion of aspects of the present invention, and it should be appreciated that FIGS. 3A and 3B provide only an illustration of an embodiment of the present invention and do not imply any limitations with regard to the variations or configurations in which different embodiments may be implemented.

FIG. 4 depicts a block diagram 400 of components of computer system 102 in accordance with an illustrative embodiment of the present invention. It should be appreciated that FIG. 4 provides only an illustration of one implementation and does not imply any limitations with regard to the environments in which different embodiments may be implemented. Many modifications to the depicted environment may be made.

Computer system 102 includes communications fabric 402, which provides communications between cache 416, memory 406, persistent storage 408, communications unit 410, and input/output (I/O) interface(s) 412. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses or a crossbar switch.

Memory 406 and persistent storage 408 are computer readable storage media. In this embodiment, memory 406 includes random access memory (RAM). In general, memory 406 can include any suitable volatile or non-volatile computer readable storage media. Cache 416 is a fast memory that enhances the performance of computer processor(s) 404 by holding recently accessed data, and data near accessed data, from memory 406.

Captioning submission program 104 can be stored in persistent storage 408 and in memory 406 for execution by one or more of the respective computer processors 404 via cache 416. In an embodiment, persistent storage 408 includes a magnetic hard disk drive. Alternatively, or in addition to a magnetic hard disk drive, persistent storage 408 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 408 can also be removable. For example, a removable hard drive can be used for persistent storage 408. Other examples include optical and magnetic disks, thumb drives, and smart cards that are inserted into a drive for transfer onto another computer readable storage medium that is also part of persistent storage 408.

Communications unit 410, in these examples, provides for communications with other data processing systems or devices. In these examples, communications unit 410 includes one or more network interface cards. Communications unit 410 can provide communications through the use of either or both physical and wireless communications links. Captioning submission program 104 can be downloaded to persistent storage 408 through communications unit 410.

I/O interface(s) 412 allows for input and output of data with other devices that can be connected to computer system 102. For example, I/O interface 412 can provide a connection to external devices 418 such as a keyboard, keypad, a touch screen, and/or some other suitable input device. External devices 418 can also include portable computer readable storage media such as, for example, thumb drives, portable optical or magnetic disks, and memory cards. Software and data used to practice embodiments of the present invention, e.g., captioning submission program 104, can be stored on such portable computer readable storage media and can be loaded onto persistent storage 408 via I/O interface(s) 412. I/O interface(s) 412 also connect to a display 420. Display 420 provides a mechanism to display data to a user and can be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention can be a system, a method, and/or a computer program product at any possible technical detail level of integration. The computer program product can include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention can be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions can also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block can occur out of the order noted in the figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

1. A method for creating crowdsourced submissions to improve text captioning associated with a video stream, the method comprising:
providing, by a captioning submission program, one or more user interface (UI) components for enabling a user to generate an indication of a text captioning error associated with the video stream;
receiving, by the captioning submission program, the indication of the text captioning error from the user wherein the user specifies a time range during which the text captioning error occurred; and
sending, by the captioning submission program, a submission to a database for further processing to improve the text captioning associated with the video stream, wherein the submission provides crowdsourced feedback of the text captioning and comprises the indication of the text captioning error and a percentage of incorrectness of the text captioning.

2. The method of claim 1, further comprising:
requesting, by the captioning submission program, the user to indicate a percentage of incorrectness associated with the text captioning error; and
receiving, by the captioning submission program, the percentage of incorrectness indicated by the user.

3. The method of claim 1, wherein the indication of the text captioning error comprises at least one of a comment associated with the text captioning error or a correction to the text captioning error.

4. The method of claim 1, further comprising:
providing, by the captioning submission program, the one or more UI components for enabling the user to enter additional information associated with the text captioning; and
receiving, by the captioning submission program, the additional information from the user.

5. The method of claim 4, wherein the additional information comprises at least one of a suggestion, a comment, a recommendation or an augmentation associated with the text captioning.

6. The method of claim 5, wherein the submission sent to the database further comprises the additional information provided by the user.

7. The method of claim 1, wherein the user provides indication of whether the user is fluent in a language associated with the text captioning via the one or more UI components provided by the captioning submission program.

8. A computer program product for creating crowdsourced submissions to improve text captioning associated with a video stream, the computer program product comprising:
one or more computer readable storage media and program instructions stored on the one or more computer readable storage media, the program instructions comprising:
program instructions to provide, by a captioning submission program, one or more user interface (UI) components for enabling a user to generate an indication of a text captioning error associated with the video stream;
program instructions to receive, by the captioning submission program, the indication of the text captioning error from the user wherein the user specifies a time range during which the text captioning error occurred; and
program instructions to send, by the captioning submission program, a submission to a database for further processing to improve the text captioning associated with the video stream, wherein the submission provides crowdsourced feedback of the text captioning and comprises the indication of the text captioning error and a percentage of incorrectness of the text captioning.

9. The computer program product of claim 8, further comprising:
program instructions to request, by the captioning submission program, the user to indicate a percentage of incorrectness associated with the text captioning error; and
program instructions to receive, by the captioning submission program, the percentage of incorrectness indicated by the user.

10. The computer program product of claim 8, wherein the indication of the text captioning error comprises at least one of a comment associated with the text captioning error or a correction to the text captioning error.

11. The computer program product of claim 8, further comprising:
program instructions to provide, by the captioning submission program, the one or more UI components for enabling the user to enter additional information associated with the text captioning; and
program instructions to receive, by the captioning submission program, the additional information from the user.

12. The computer program product of claim 11, wherein the additional information comprises at least one of a suggestion, a comment, a recommendation or an augmentation associated with the text captioning.

13. The computer program product of claim 12, wherein the submission sent to the database further comprises the additional information provided by the user.

14. The computer program product of claim 8, wherein the user provides indication of whether the user is fluent in a language associated with the text captioning via the one or more UI components provided by the captioning submission program.

15. A computer system for creating crowdsourced submissions to improve text captioning associated with a video stream, the computer system comprising:
one or more computer processors;
one or more computer readable storage media;
program instructions stored on the one or more computer readable storage media for execution by at least one of the one or more processors, the program instructions comprising: program instructions to provide, by a captioning submission program, one or more user interface (UI) components for enabling a user to generate an indication of a text captioning error associated with the video stream;
program instructions to receive, by the captioning submission program, the indication of the text captioning error from the user wherein the user specifies a time range during which the text captioning error occurred; and
program instructions to send, by the captioning submission program, a submission to a database for further processing to improve the text captioning associated with the video stream, wherein the submission provides crowdsourced feedback of the text captioning and comprises the indication of the text captioning error and a percentage of incorrectness of the text captioning.

16. The computer system of claim 15, further comprising:
program instructions to request, by the captioning submission program, the user to indicate a percentage of incorrectness associated with the text captioning error; and
program instructions to receive, by the captioning submission program, the percentage of incorrectness indicated by the user.

17. The computer system of claim 15, wherein the indication of the text captioning error comprises at least one of a comment associated with the text captioning error or a correction to the text captioning error.

18. The computer system of claim 15, further comprising:
program instructions to provide, by the captioning submission program, the one or more UI components for enabling the user to enter additional information associated with the text captioning; and
program instructions to receive, by the captioning submission program, the additional information from the user.

19. The computer system of claim 18, wherein the additional information comprises at least one of a suggestion, a comment, a recommendation or an augmentation associated with the text captioning.

20. The computer system of claim 19, wherein the submission sent to the database further comprises the additional information provided by the user.
